(19) United States
(12) Patent Application Publication
(10) Pub. No.: US 2007/0225107 A1
(43) Pub. Date: Sep. 27, 2007

(54) Vehicle gear change device

(76) Inventor: Jen-Chih Liu, Kaohsiung City (TW)

Correspondence Address: JEN-CHIH LIU, 235 Chung-Ho, Box 8-24, Taipei, TW

(21) Appl. No.: 11/386,983

(22) Filed: Mar. 23, 2006

(51) Int. Cl. F16H 3/44

(52) U.S. Cl. 475/269; 475/298

(57) ABSTRACT

A vehicle gear change device comprising a casing, a sun gear, a planet frame, a planet gear, an inner gear, a switching driving unit; a rotary shaft, and a switch gear switching unit; the switch gear switching unit including a moving fork and a cam toggle. The rotary shaft is installed in a casing. The sun gear is engaged to the rotary shaft; and the sun gear is driven by an external power driving element. The sun gear is engaged to a planet gear which drives a planet frame. The sun gear has a driving teeth. The planet gear in the planet frame is engaged to an annular inner gear which is at an external side of the planet gear; and the inner gear has a driving teeth. The switching driving unit is connected to the rotary shaft; and the switching driving unit is movable horizontally along the rotary shaft and is switchable between the sun gear and the inner gear.

### FIELD OF THE INVENTION

The present invention relates to switch gears, and in particular to a vehicle gear change device which has a simple and firm structure. The assembly work can be performed easily and quickly.

### BACKGROUND OF THE INVENTION

Gear change units are frequently used in many fields, such as used in beach cars.

The feature of the gear change of a beach car is that a first control portion of a control unit is engaged to a driving portion of a driving wheel in normal state. The car is in a forward moving state. When the first control portion is separate from the driving portion and the second control portion is engaged to an operation portion, the rotary force of a power rotary shaft will drive an operation gear so as to drive a direction change gear. Then the driving portion is driven so that the driving gear rotates. Thus the car is in a reverse moving state.

In this prior art, the control rod of the control unit penetrates through a bottom plate (planet frame of a planet gear in the gear set) of a gear set along a direction of a horizontal rotary shaft. The manufacturing process is inconvenient and time is consumed in assembly. The structure area is small and the whole structure is not ideal.

In another reverse gear of a beach car, the wheel shaft is installed with a gear set. A rotary shaft passes through a casing. The gear set is formed by an outer gear and an inner gear. The power of engine is transferred by a chain. The outer gear is installed with a bearing so that it can be installed to a wheel shaft. An inner wall of the casing is installed with a plurality of umbrella gear, a second umbrella gear, and a third umbrella gear which are engageable to one another. The second umbrella gear is at a middle portion which serves to transfer between the first umbrella gear and the third umbrella gear. The first and third umbrella gears are oppositely arranged. A wheel shaft is pivotal installed through the first and third umbrella gears. The inner gear of the gear set is installed to a hub of the first umbrella gear. A surface of a wheel shaft is formed with a key groove between the first and third umbrella gears. A slideable cover is installed in the key groove. The slideable cover is moved by a gear change bar in the casing. Two ends of the slideable cover are installed with engaging teeth. The first and third umbrella gears are installed with teethed grooves for engaging the engaging teeth of the slideable cover.

However only one gear, the second umbrella gear, is used as a middle gear for transferring the power. The structure is weak.

### SUMMARY OF THE INVENTION

Accordingly, the primary object of the present invention is to provide a vehicle gear change device which has a simple and firm structure. The assembly work can be performed easily and quickly.

To achieve above objects, the present invention provides a vehicle gear change device which comprises a casing, a sun gear, a planet frame, a planet gear, an inner gear, a switching driving unit; a rotary shaft, and a switch gear switching unit; the switch gear switching unit including a moving fork and a cam toggle. The rotary shaft is installed in a casing. The sun gear is engaged to the rotary shaft; the sun gear is driven by an external power driving element. The sun gear is engaged to a planet gear which drives a planet frame. The sun gear has a driving teeth. The planet gear in the planet frame is engaged to an annular inner gear which is at an external side of the planet gear; the inner gear has a driving teeth. The switching driving unit is connected to the rotary shaft 6; the switching driving unit is movable horizontally along the rotary shaft and is switchable between the sun gear and the inner gear.

The various objects and advantages of the present invention will be more readily understood from the following detailed description when read in conjunction with the appended drawing.

### BRIEF DESCRIPTION OF THE DRAWINGS

FIG. 1 shows the embodiment of the present invention.

FIG. 2 shows the schematic view about the gear switching of the present invention.

FIG. 3 shows the switching driving unit of the present invention.

FIG. 4 is a left side view of the present invention.

FIG. 5 is a right side view of the present invention.

FIG. 6 is a schematic view along line 6-6 of FIG. 5.

FIG. 7 shows the annular inner gear of the present invention.

FIG. 8 shows the right side view along line 8-8 of FIG. 7.

FIG. 9 shows the right side view of FIG. 7.

FIG. 10 is a left side view of FIG. 7.

FIG. 11 shows the cam toggle of the present invention.

FIG. 12 is a right side view of FIG. 11.

FIG. 13 is an elevational view of FIG. 11.

FIG. 14 is an assembled schematic view about the cam toggle and moving fork of the present invention.

FIG. 15 is a right side view of FIG. 14.

FIG. 16 is an elevational view of FIG. 14.

FIG. 17 is an assembled schematic view about the cam toggle, moving fork and guide block of the present invention.

FIG. 18 shows another embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

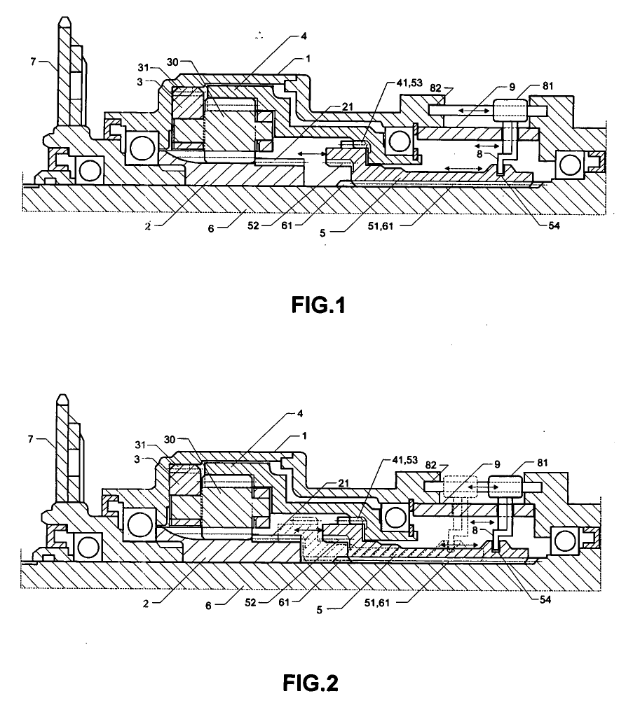

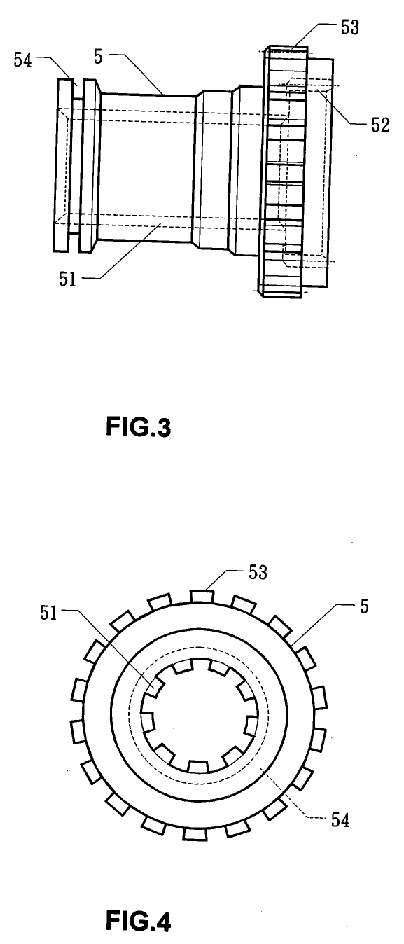

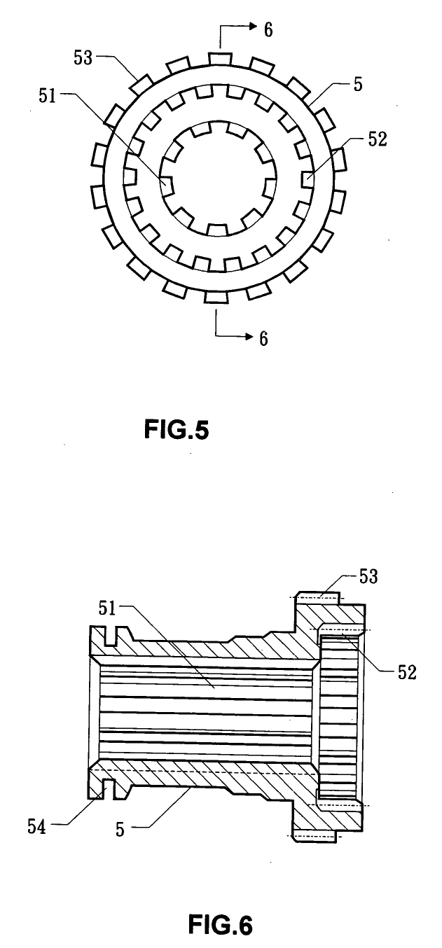

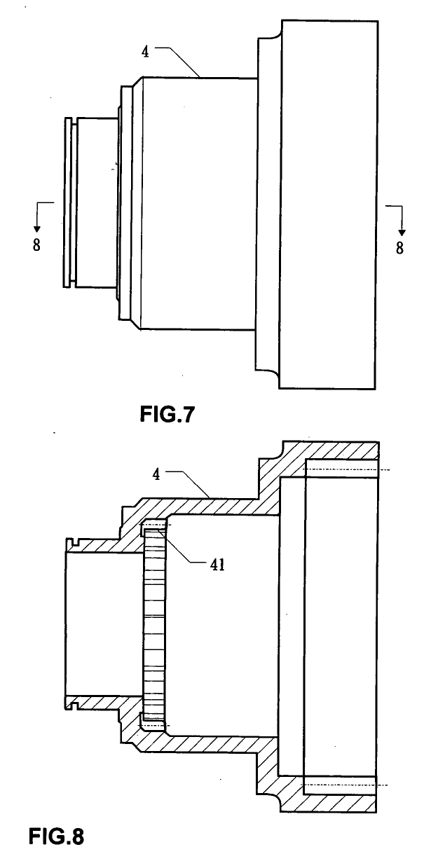

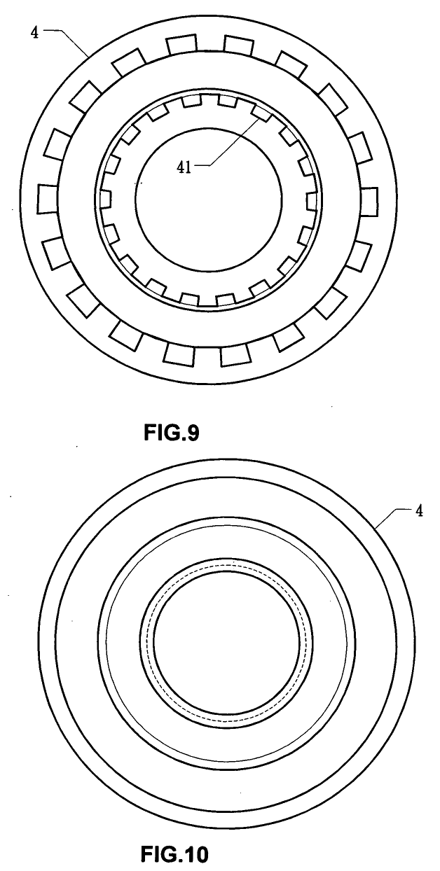

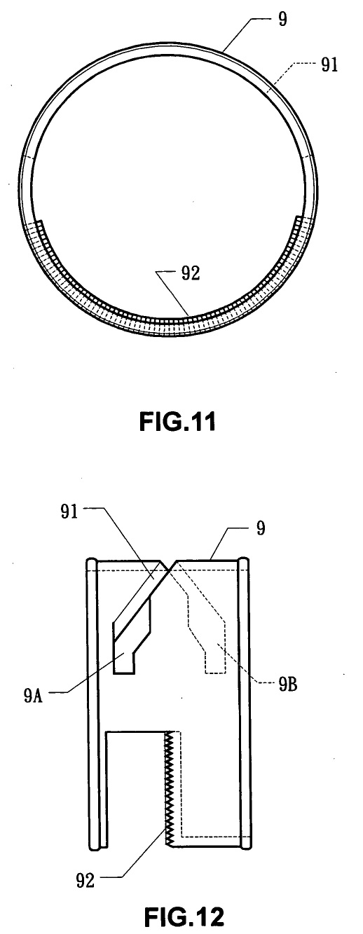

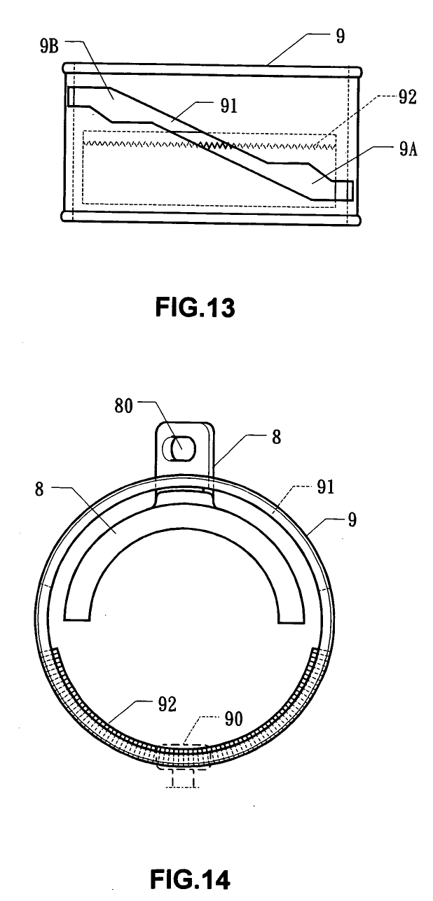

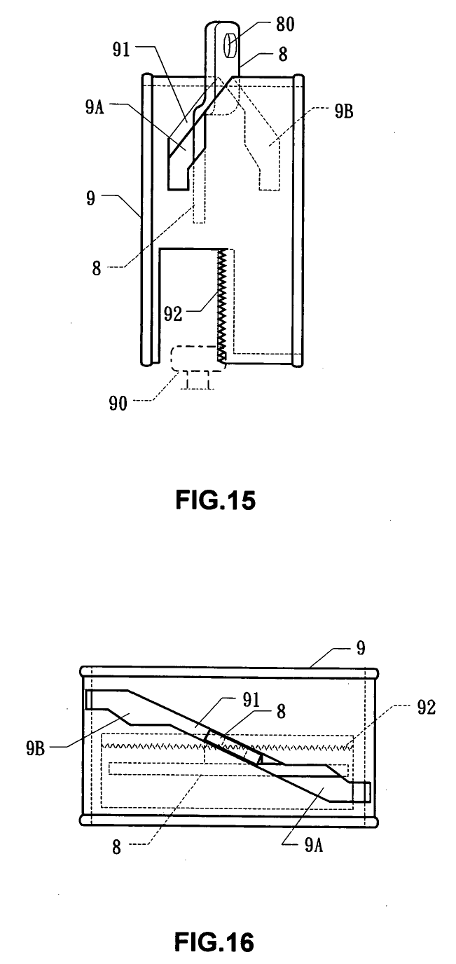

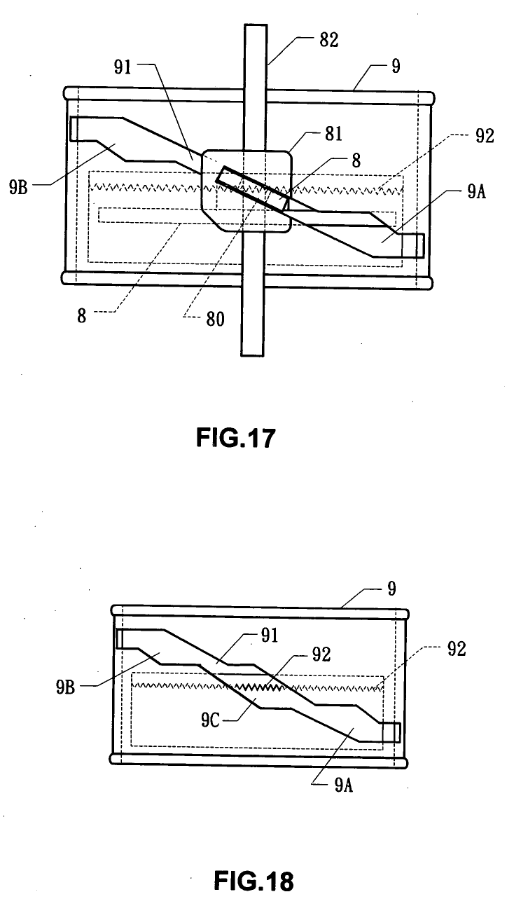

Referring to FIG. 1, the structure of the present invention is illustrated. The present invention has the following elements.

A rotary shaft 6 is installed in a casing 1. A sun gear 2 is engaged to the rotary shaft 6. The sun gear 2 is driven by an external power driving element 7 (such as a driving chain). The sun gear 2 is engaged to a planet gear 30 which drives a planet frame 3. The sun gear 2 has a driving teeth 21. The rotary shaft 6 has a protrusion 61 having a recess therein.

The planet gear 30 in the planet frame 3 is engaged to an annular inner gear 4 which is at an external side of the planet gear 30. The inner gear 4 has a driving teeth 41. The planet frame 3 is fixed to the casing 1 and thus it is non-rotatable by using an embedding portion 31 to receive a part of the casing 1.

A switching driving unit 5 has a strip 51. The strip 51 can be embedded into the recess of the protrusion 61 of the rotary shaft 6. The switching driving unit 5 has a first driving teeth 52 and a second driving teeth 53. The first driving teeth 521 serves to engage the driving teeth 21 of the sun gear 2 and the second driving teeth 53 serves to engage the driving teeth 41 of the inner gear 4. The sun gear 2 has an annular recess 54.

A moving fork 8 penetrates through a wall of the casing 1 and is vertical to the rotary shaft 6. The moving fork 8 can be positioned to the annular recess 54 of the switching driving unit 5. The moving fork 8 has a penetrating hole 80. A guide bar 82 passes through the penetrating hole 80 so that the moving fork 8 is movable axially along the guide bar 82. A guide block 81 serves to fix the moving fork 8 to the guide bar 82.

The cam toggle 9 serves to drive the moving fork 8. The cam toggle 9 has a penetrating guide trench 91. The guide trench 91 is formed with a forward gear section 9A and a rearward gear section 9B. When the cam toggle 9 rotates, the moving fork 8 is displaced to be in the forward gear section 9A or a reverse gear section 9B. The cam toggle 9 has an engaging tooth surface 92 for engaging a driving teeth 90. The driving gear 90 rotates in two directions by the rotation of the cam toggle 9.

Referring to FIG. 18, in the guide trench 91, a neutral gear section can be formed between the forward gear section 9A and the rearward gear section 9B. By the null driving section, the switching driving unit 5 is positioned between the driving teeth 21 of the sun gear 2 and the driving teeth 41 of the inner gear 4 so that the switching driving unit 5 is not engaged to the driving teeth 21 of the sun gear 2 and the driving teeth 41 of the inner gear 4. It has the effect of neutral gear positions.

When the driving gear 90 drives the cam toggle 9 to make the moving fork 8 move inwards so as to drive the switching driving unit 5 to engage the driving teeth 21 of the sun gear 2, the power of the external power driving unit 7 will transfer to the sun gear 2 and then to the rotary shaft 6 by the switching driving unit 5. Thereby the rotary shaft 6 will rotate in a forward moving direction.

When the driving gear 90 drives the cam toggle 9 to make the moving fork 8 move outwards so as to drive the switching driving unit 5 to engage the driving teeth 41 of inner gear 4, the power of the external power driving unit 7 will transfer to the sun gear 2 and then to the inner gear 4 engaged to the planet gear 30 by the switching driving unit 5. Thereby the rotary shaft 6 will rotate in a backward moving direction.

Advantages of the present invention will be description herein. The present invention has a simple and firm structure. The assembly work can be performed easily and quickly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vehicle gear change device comprising a casing, a sun gear, a planet frame, a planet gear, an inner gear, a switching driving unit; a rotary shaft, and a switch gear switching unit; the switch gear switching unit including a moving fork and a cam toggle; wherein
the toggle has a recess for positioning the switching driving unit to be moved axially;
the switching driving unit is connected to the rotary shaft and is switchable between the sun gear and the inner gear;
the moving fork penetrating through the casing to be connected to the switching driving unit for controlling the switching of the switching driving unit to be engaged with the sun gear or the inner gear; and
the cam toggle is arranged around the moving fork; the cam toggle has a guide trench for guiding the moving fork.

2. The vehicle gear change device as claimed in claim 1, wherein the moving fork penetrates through a wall of the casing and is vertical to the rotary shaft; the moving fork can be positioned to the annular recess of the switching driving unit.

3. The vehicle gear change device as claimed in claim 1, wherein the rotary shaft is installed in a casing; the sun gear is engaged to the rotary shaft; the sun gear is driven by an external power driving element; the sun gear is engaged to a planet gear which drives a planet frame; the sun gear has a driving teeth for engaging with the switching driving unit.

4. The vehicle gear change device as claimed in claim 1, wherein the planet gear in the planet frame is engaged to an annular inner gear which is at an external side of the planet gear; and the inner gear has a driving teeth for engaging the driving teeth of the switching driving unit.

5. The vehicle gear change device as claimed in claim 1, wherein the planet frame is fixed to the casing without rotation.

6. The vehicle gear change device as claimed in claim 1, wherein the switching driving unit has a strip; the strip can be embedded into a recess of a protrusion of the rotary shaft; the switching driving unit has a first driving teeth and a second driving teeth; the first driving teeth serves to engage the driving teeth of the sun gear and the second driving teeth serves to engage the driving teeth of the inner gear.

7. The vehicle gear change device as claimed in claim 1, wherein the switching driving unit has a recess for receiving the moving fork.

8. The vehicle gear change device as claimed in claim 1, wherein the moving fork has a penetrating hole; and a guide bar passes through the penetrating hole so that the moving fork is movable axially along the guide bar.

9. The vehicle gear change device as claimed in claim 1, wherein the cam toggle has a penetrating guide trench; the guide trench is formed with a forward gear section and a rearward gear section; when the cam toggle rotates, the moving fork is displaced to be in the forward gear section or a reverse gear section; and the cam toggle has an engaging tooth surface for engaging a driving teeth; the driving gear rotates in two directions by the rotation of the cam toggle.

10. The vehicle gear change device as claimed in claim 1, wherein the cam toggle has a penetrating guide trench; the guide trench is formed with a forward gear section and a rearward gear section; when the cam toggle rotates, the moving fork is displaced to a the forward gear section or a reverse gear section; and the cam toggle has an engaging tooth surface for engaging a driving teeth; the driving gear rotates bi-directionally by the rotation of the cam toggle; a neutral gear section is formed between the forward gear section and the rearward gear section.

11. A vehicle gear change device comprising a casing, a sun gear, a planet frame, a planet gear, an inner gear, a switching driving unit; a rotary shaft, and a switch gear switching unit; the switch gear switching unit including a moving fork and a cam toggle; wherein
the rotary shaft is installed in a casing; the sun gear is engaged to the rotary shaft; the sun gear is driven by an external power driving element;
the sun gear is engaged to a planet gear which drives a planet frame; the sun gear has a driving teeth;
the planet gear in the planet frame is engaged to an annular inner gear which is at an external side of the planet gear; the inner gear has a driving teeth; and
the switching driving unit is connected to the rotary shaft; the switching driving unit is movable horizontally along the rotary shaft and is switchable between the sun gear and the inner gear.

12. The vehicle gear change device as claimed in claim 11, wherein the moving fork penetrates through the casing to be connected to the switching driving unit for controlling the switching of the switching driving unit to be engaged with the sun gear or the inner gear.

13. The vehicle gear change device as claimed in claim 11, wherein the planet frame is fixed to the casing without rotation.

14. The vehicle gear change device as claimed in claim 11, wherein the switching driving unit has a strip; the strip can be embedded into a recess of a protrusion of the rotary shaft; the switching driving unit has a first driving teeth and a second driving teeth; the first driving teeth serves to engage the driving teeth of the sun gear and the second driving teeth serves to engage the driving teeth of the inner gear.

15. The vehicle gear change device as claimed in claim 11, wherein the switching driving unit has a recess for receiving the moving fork.

16. A vehicle gear change device comprise a moving fork and a cam toggle of a switching driving unit; wherein the cam toggle is installed at an outer periphery of the moving fork; and the cam toggle is formed with guide trench for guiding the moving fork to move axially.

17. The vehicle gear change device as claimed in claim 16, wherein the moving fork vertically penetrates through the casing to be connected to the switching driving unit.

18. The vehicle gear change device as claimed in claim 16, wherein the moving fork penetrates through the guiding trench of the cam toggle.

19. The vehicle gear change device as claimed in claim 16, wherein the cam toggle has a penetrating guide trench; the guide trench is formed with a forward gear section and a rearward gear section; and the cam toggle has an engaging tooth surface for engaging a driving teeth; the driving gear rotates in bi-directionally by the rotation of the cam toggle.

20. The vehicle gear change device as claimed in claim 1, wherein the cam toggle has a penetrating guide trench; the guide trench is formed with a forward gear section and a rearward gear section; and the cam toggle has an engaging tooth surface for engaging a driving teeth; the driving gear rotates in bidirectionally by the rotation of the cam toggle; a neutral gear section is formed between the forward gear section and the rearward gear section.
